(19) United States
(12) Patent Application Publication
(10) Pub. No.: US 2008/0293490 A1
(43) Pub. Date: Nov. 27, 2008

(54) System For Multifuctional Remote Control

(75) Inventor: Se Yong Rhee, Seoul (KR)

Correspondence Address: YOUNG & THOMPSON, 209 Madison Street, Suite 500, ALEXANDRIA, VA, 22314, US

(73) Assignee: Taewon Lighting Co., Ltd., Seoul (KR)

(21) Appl. No.: 12/097,691

(22) PCT Filed: Mar. 24, 2006
(86) PCT No.: PCT/KR2006/001100

§ 371 Date: Jun. 16, 2008

(51) Int. Cl. A63F 13/00; A63F 9/24

(52) U.S. Cl. 463/35; 463/44; 463/31

(57) ABSTRACT

A system for multifunctional remote control is disclosed. The system comprises a remote control (100) for connecting mechanically and electrically with a cartridge (200), reading data stored in the cartridge through the first connection unit (110), storing the read data, and setting the registration of use; and a cartridge (200) for mechanically and electronically connecting with the remote control (100), receiving data from a user computer (10), storing the received data, and transmitting/receiving infrared signal to/from a controlled product.

### TECHNICAL FIELD

The present invention relates to a system for multifunctional remote control. More concretely, it relates to a system for multifunctional remote control which provides control code data and multimedia contents data of an electronic device for a cartridge, which is detachable in a remote control, via a user computer connected with the internet to control various electronic devices and replay multimedia contents.

### BACKGROUND ART

Generally, a user inputs the maker and model name of the reproducer including an A/V system into a multifunctional remote control by using the built-in control codes. However, a multifunctional remote control is integrated into a control code processing part and designed to perform only one function, unable to be used for different purposes.

Accordingly, a remote control was developed that further included a monitor displaying the operating information of an operation button and the program according to the monitor. But because PC software connected with the remote control was manufactured for restrictive use, it was difficult to have an effective technical support.

### DISCLOSURE

### Technical Problem

The present invention is designed to solve the above described problems, and therefore it is the object of the present invention to provide a system for multifunctional remote control which receives control code data and multimedia contents data of an electronic device from a user computer connected with the internet to control various electronic devices and replay multimedia contents.

The other object of the present invention is to provide a system for multifunctional remote control which is detachable from a remote control and can provide multifunctional remote control system which can control a new multimedia device just by adding new communications circuit and function to a cartridge and a user computer.

### Technical Solution

In order to achieve the above objectives, the system for multifunctional remote control comprises a remote control 100 for connecting mechanically and electrically with a cartridge 200, reading data stored in the cartridge through the first connection unit 110, storing the read data, and setting the registration of use; and a cartridge 200 for connecting mechanically and electrically with the remote control 100, receiving data from a user computer 10, storing the received data, and transmitting/receiving infrared signal to/from a controlled product.

The remote control 100 comprises a first connection unit 110 for connecting mechanically and electrically with the cartridge 200; a data reader unit 120 for reading data stored in the cartridge through the first connection unit 110; a memory unit 130 for storing data read from the data reader unit 120. a key input unit 140 having a plurality of keys including a setting key for the registration of use; and a central processing unit 150 for controlling the data reader unit 120, memory unit 130 and key input unit 140.

The cartridge 200 comprises a second connection unit 210 for connecting mechanically and electrically with the remote control 100; a interface unit 220 for receiving data from the user computer 10; a memory unit 230 for storing data received by the interface unit 220; an infrared transceiver 240 for transmitting/receiving the infrared signal to/from a controlled product; a MCU 250 for controlling the interface unit 220, the memory unit 230 and infrared transceiver 240.

The system for multifunctional remote control further comprises a speaker unit 160 for outputting audio data of the multimedia contents stored in the memory unit 130; and a display unit 170 for outputting moving-picture data of the multimedia contents stored in the memory unit 130, wherein the speaker unit 160 and display unit 170 are connected to the central processing unit 150.

The display unit 170 is based on the SVG (Scalable Vector Graphics).

The data are code data of the electronic device provided by a server connected to the internet through the cartridge control software 11 mounted on the above software.

The server is a database server 20 which collects code data from an electronic device maker and provides to the computer 10.

The server is an electronic device maker server 30.

The data are contents data provided by the server connected to the internet N through the cartridge control software 11 mounted on the computer 10.

The server is a content server 40.

The cartridge 200 further comprises a communications circuit of DALI, and the computer 10 further comprises the function of DALI.

The cartridge 200 further comprises a communications circuit of ZigBee, and the computer 10 further comprises the function of ZigBee.

The cartridge 200 further comprises a communications circuit of HomeNet, and the computer 10 further comprises the function of HomeNet.

The cartridge 200 further comprises a communications circuit of BlueTooth, and the computer 10 further comprises the function of BlueTooth.

### DESCRIPTION OF DRAWINGS

FIG. 1 is a configuration diagram of a system for multifunctional remote control according to one preferred embodiment of the present invention.

FIG. 2 is a configuration diagram of a remote control according to one preferred embodiment of the present invention.

FIG. 3 is a configuration diagram of a cartridge according to one preferred embodiment of the present invention.

FIG. 4 is an illustration showing the process of the remote control according to one preferred embodiment of the present invention which receives control code data of an electronic device through a user computer.

FIG. 5 is an illustration showing the process of the remote control according to another preferred embodiment of the present invention which receives control code data of an electronic device through a user computer.

FIG. 6 is an illustration showing the process of the remote control according to one preferred embodiment of the present invention which receives multimedia contents data through a user computer.

### BEST MODE

Hereinafter, the present invention is circumstantially explained with reference to the attached drawings.

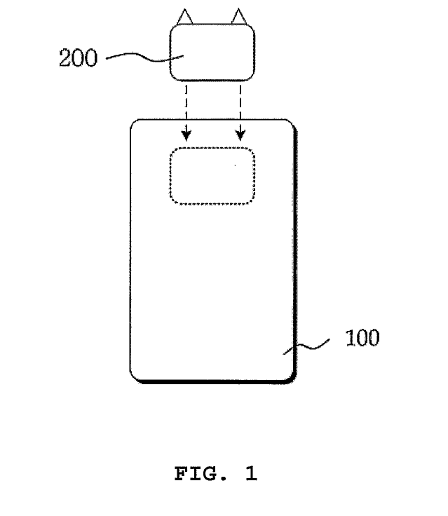

With reference to FIGS. 1 through 3, the configuration of a system for multifunctional remote control according to one preferred embodiment of the present invention is explained.

Before the preferred embodiment of the present invention is explained, the understanding is desirable in the present invention that USB (Universal Serial Bus) interface is installed at the following cartridge (200) and then the exchange of data is possible between the cartridge and a user computer. And that follows USB agreement of the IEEE.

As shown in FIG. 1, a system for multifunctional remote control includes a remote control 100 and cartridge 200.

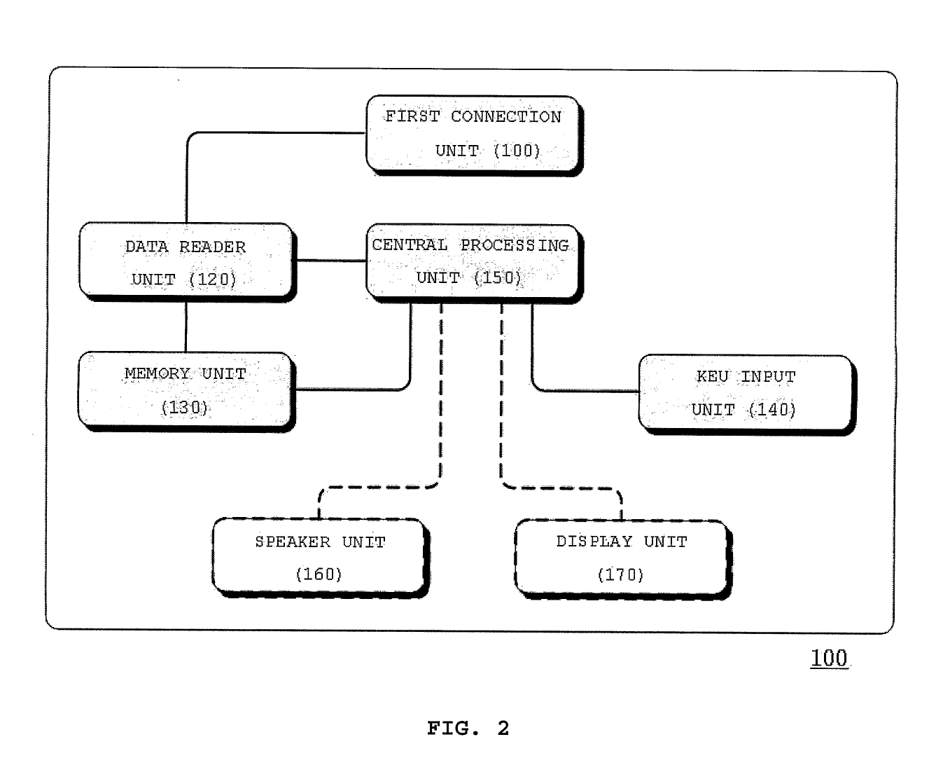

As shown in FIG. 2, the remote control 100 includes a first connection unit 110, a data reader unit 120, a memory unit 130, a key input unit 140 and a central processing unit 150. The first connection unit 110 mechanically and electrically connects with the following cartridge 200. Moreover, the data reader unit 120 reads data stored in the cartridge through the first connection unit 110. Moreover, the memory unit 130 stores data read from the data reader unit 120. Moreover, the key input unit 140 is comprised of a plurality of keys including a setting key for the registration of use. And the central processing unit 150 controls the data reader unit 120, memory unit 130 and key input unit 140.

Preferably, the above-described remote control 100 can further include the speaker unit 160 and display unit 170. In this embodiment, the display unit 170 is based on the SVG (Scalable Vector Graphics) which process graphic objects as a vector method to maintain the quality of a graphic regardless of a resolution.

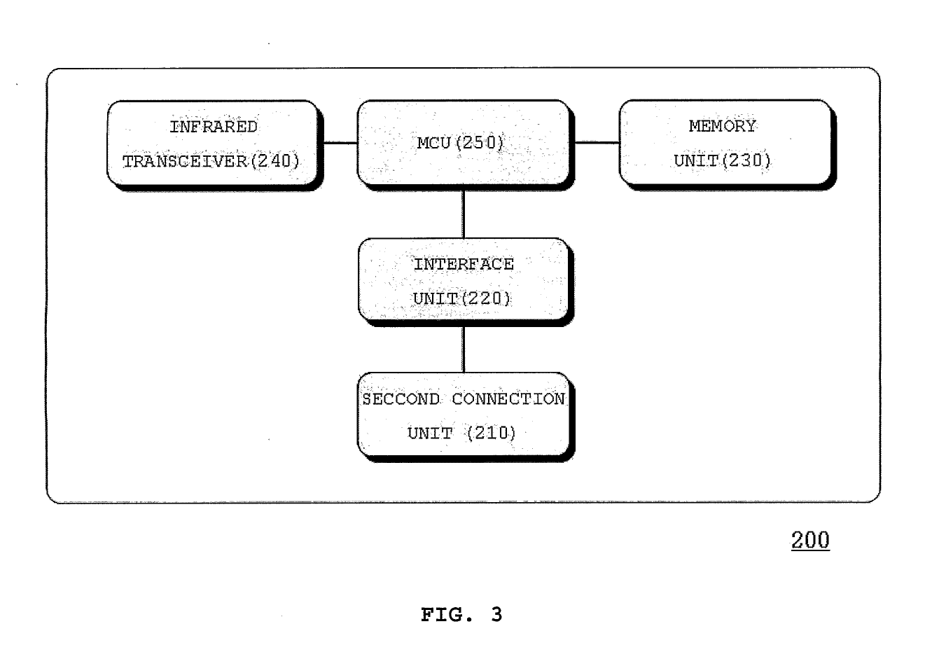

As shown in FIG. 3, the cartridge 200, which is detachable in the remote control, includes a second connection unit 210, an interface unit 220, a memory unit 230, an infrared transceiver 240 and a MCU (Micro Control Unit, 250). The second connection unit 210 mechanically and electrically connects with the remote control 100. Moreover, the interface unit 220 receives data from the following user computer 10. Moreover, the memory unit 230 stores data received by the interface unit 220. Moreover, the infrared transceiver 240 transmits/receives the infrared signal to/from a controlled product. And the MCU 250 controls the interface unit 220, the memory unit 230 and infrared transceiver 240.

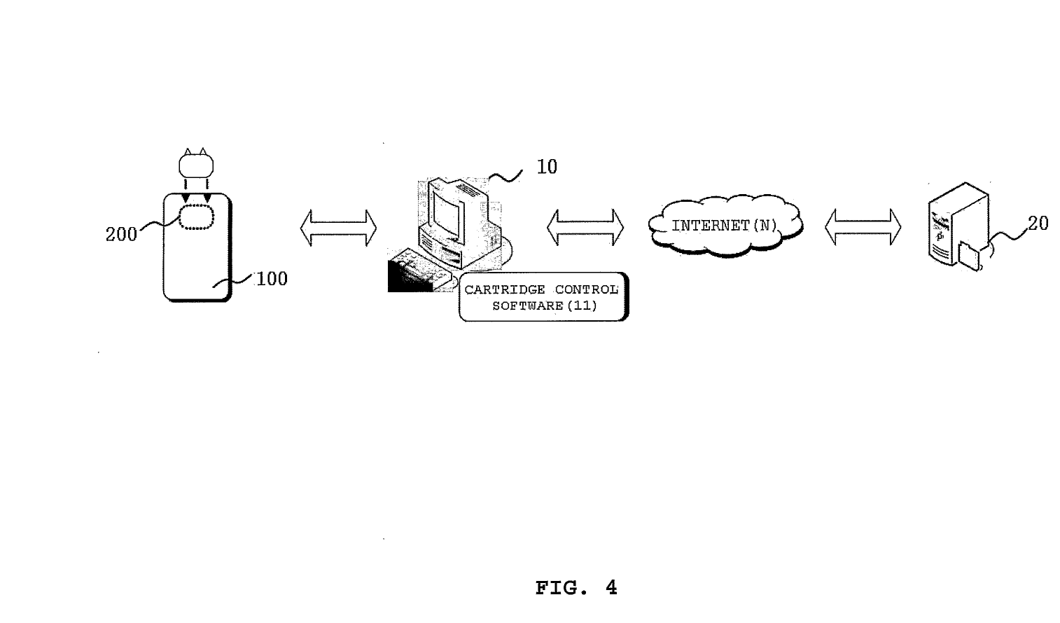

Hereinafter, with reference to FIGS. 4 through 6, disclosed is the operation example of a multifunctional remote control using data (control code data of an electronic device and multimedia contents data) provided from a user computer 10.

First, the operation example for controlling the various electronic devices is disclosed.

As shown in FIG. 4, a user computer (will be referred to as ‘computer’, 10) is connected to a database server 20 through the internet N. And the computer is mounted with the cartridge control software 11 which receives the control code data (will be referred to as ‘code data’) of various electronic devices which are provided from the database server 20 and stores them.

In other words, the cartridge control software 11 receives code data of various electronic devices from the database server 20 which collects code data from an electronic device maker through the internet N and stores them.

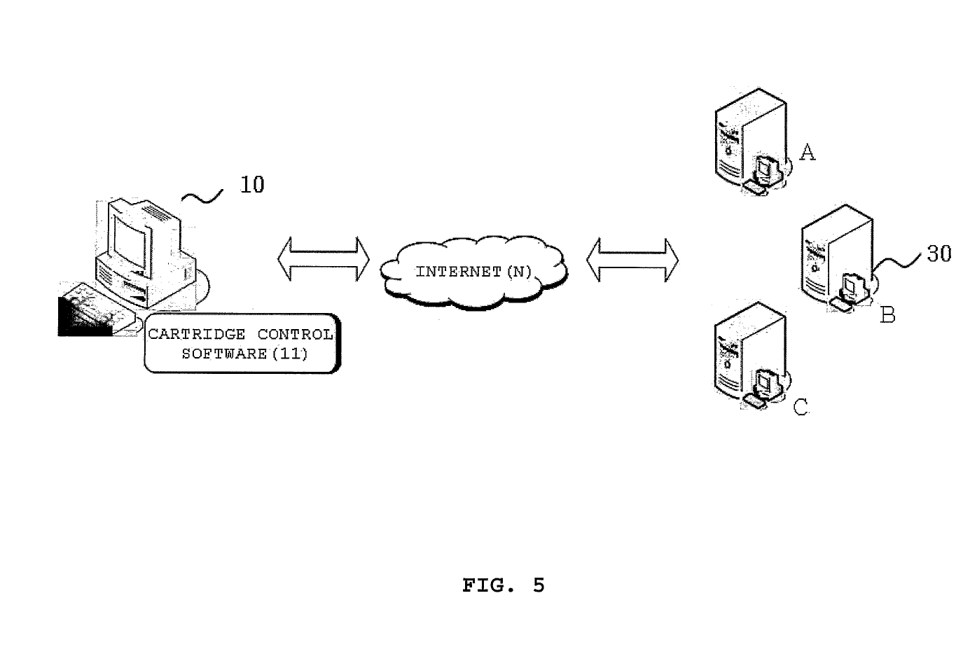

Moreover, as shown in FIG. 5, the cartridge control software 11 can individually receive code data through the internet N from each electronic device maker (A, B, C) server 30.

Next, the operation example through the multimedia contents function is disclosed.

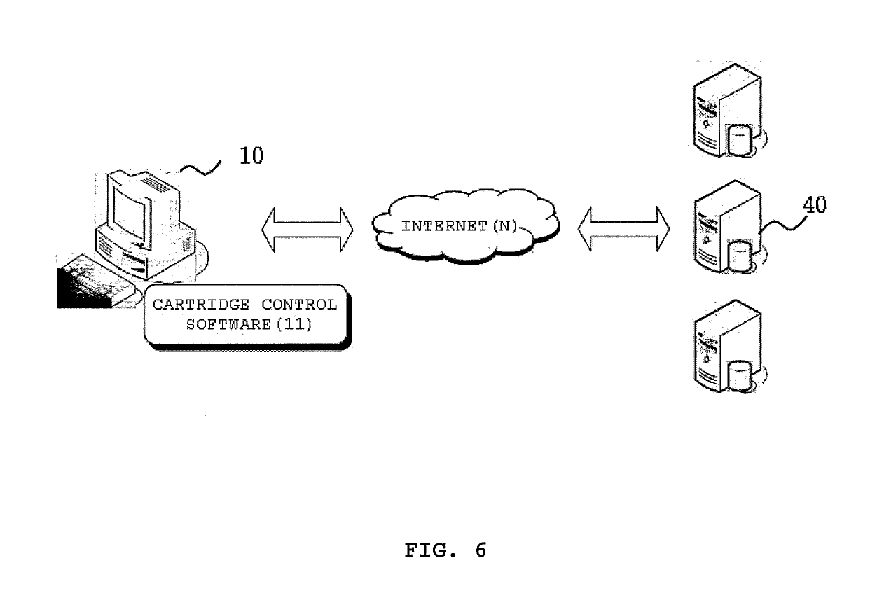

As shown in FIG. 6, the computer 10 is connected to a plurality of content servers 40 through the internet N. And the computer is mounted with the cartridge control software 11 which receives the multimedia contents data (will be referred to as ‘contents data’) provided from the content server 40 and store them.

In other words, the cartridge control software 11 receives various contents data which a plurality of content servers 40 provide through the internet N and stores them.

In the remote control operation example through the multimedia contents function, when a user tries to add the media interface including DALI, ZigBee, HomeNet and BlueTooth, etc., a user adds the corresponding communications circuit in the interface unit 220 of the cartridge 200 and adds the corresponding function in the cartridge control software 11 of the computer 10 to use the remote control that corresponds with the demand of a user.

In the technical field in which the present invention belongs to, the present invention described above is not restricted to the embodiment and the attached drawing which we describe above since many substitution, deformation and change are possible in the range that does not deviate from a technical idea as to a person having a conventional knowledge.

### INDUSTRIAL APPLICABILITY

As mentioned above, according to the present invention, it is possible to provide a system for multifunctional remote control which provides control code data and multimedia contents data of an electronic device for a cartridge, which is detachable in a remote control, via a user computer to control various electronic devices and replay multimedia contents including game contents, education contents, and etc.

Also, it is possible to provide a system for multifunctional remote control which only adds new communications circuit and new function to a user computer and a cartridge which is detachable from a remote control to control new multimedia device.

1. A system for multifunctional remote control, comprising:
a remote control 100 for connecting mechanically and electrically with a cartridge 200, reading data stored in the cartridge through the first connection unit 110, storing the read data, and setting the registration of use; and
a cartridge 200 for connecting mechanically and electrically with the remote control 100, receiving data from a user computer 10, storing the received data, and transmitting/receiving infrared signal to/from a controlled product.

2. The system for multifunctional remote control according to claim 1, wherein the remote control 100 comprises:
a first connection unit 110 for connecting mechanically and electrically with the cartridge 200;
a data reader unit 120 for reading data stored in the cartridge through the first connection unit 110;
a memory unit 130 for storing data read from the data reader unit 120.
a key input unit 140 having a plurality of keys including a setting key for the registration of use; and
a central processing unit 150 for controlling the data reader unit 120, memory unit 130 and key input unit 140.

3. The system for multifunctional remote control according to claim 1, wherein the cartridge 200 comprises:
a second connection unit 210 for connecting mechanically and electrically with the remote control 100;
a interface unit 220 for receiving data from the user computer 10;
a memory unit 230 for storing data received by the interface unit 220;
an infrared transceiver 240 for transmitting/receiving the infrared signal to/from a controlled product;
a MCU 250 for controlling the interface unit 220, the memory unit 230 and infrared transceiver 240.

4. The system for multifunctional remote control according to claim 2, further comprising:
a speaker unit 160 for outputting audio data of the multimedia contents stored in the memory unit 130; and
a display unit 170 for outputting moving-picture data of the multimedia contents stored in the memory unit 130,
wherein the speaker unit 160 and display unit 170 are connected to the central processing unit 150.

5. The system for multifunctional remote control according to claim 4, wherein the display unit 170 is based on the SVG (Scalable Vector Graphics).

6. The system for multifunctional remote control according to claim 1, wherein the data are code data of the electronic device provided by a server connected to the internet through the cartridge control software 11 mounted on the above software.

7. The system for multifunctional remote control according to claim 6, wherein the server is a database server 20 which collects code data from an electronic device maker and provides to the computer 10.

8. The system for multifunctional remote control according to claim 6, wherein the server is an electronic device maker server 30.

9. The system for multifunctional remote control according to claim 1, wherein the data are contents data provided by the server connected to the internet N through the cartridge control software 11 mounted on the computer 10.

10. The system for multifunctional remote control according to claim 9, wherein the server is a content server 40.

11. The system for multifunctional remote control according to claim 3, wherein the cartridge 200 further comprises a communications circuit of DALI, and the computer 10 further comprises the function of DALI.

12. The system for multifunctional remote control according to claim 3, wherein the cartridge 200 further comprises a communications circuit of ZigBee, and the computer 10 further comprises the function of ZigBee.

13. The system for multifunctional remote control according to claim 3, wherein the cartridge 200 further comprises a communications circuit of HomeNet, and the computer 10 further comprises the function of HomeNet.

14. The system for multifunctional remote control according to claim 3, wherein the cartridge 200 further comprises a communications circuit of BlueTooth, and the computer 10 further comprises the function of BlueTooth.
